(19) United States
(12) Patent Application Publication
(10) Pub. No.: US 2022/0343420 A1
(43) Pub. Date: Oct. 27, 2022

(54) FLEXIBLE, MULTI-CONSTRAINT SEGMENTATION SYTEMS

(71) Applicant: INTUIT INC., Mountain View, CA (US)

(72) Inventors: Xue HAN, Mountain View, CA (US); Zhicheng XUE, Mountain View, CA (US)

(73) Assignee: INTUIT INC., Mountain View, CA (US)

(21) Appl. No.: 17/239,290

(22) Filed: Apr. 23, 2021

(51) Int. Cl. G06Q 40/02; G06K 9/62; G06F 17/11

(52) U.S. Cl. CPC G06Q 40/025; G06K 9/622; G06F 17/11

(57) ABSTRACT

Systems and methods for flexible, multi-constraint risk segmentation.

### BACKGROUND OF THE DISCLOSURE

Credit risk scoring is the use of numerical tools to determine the likelihood that a prospective borrower will default on a loan. A loan goes into default if a scheduled payment is late for a prolonged period of time. In general, providers of capital segment prospective borrowers based on a credit risk score or other similar scores (e.g., FICO Score). Borrower segmentation is used to differentiate loan or credit applications based on the associated risk of default; this enables more accurate decisions for loan approvals and pricing (e.g., interest rate, loan term, loan amount, etc.). This is ultimately used by providers to attract creditworthy and responsible customers that can generate profits while controlling losses from non-payment on defaulted loans.

When determining credit worthiness, existing providers of capital will segment potential customers based on credit risk scores or loan risk scores using various techniques such as machine learning models or simply by accessing external credit bureaus. These models and techniques are used separately at various steps of lending policy procedure, such as the eligibility determination stage, decision making approval stage, pricing stages, etc. In addition, segmentation is commonly performed using: 1) human business judgements that bin certain ranges of scores together or 2) a tree model as guidance to determine cutoff points. However, there is no concrete metric to evaluate how well the segmentation performs regarding the differentiation between loan default rates. Furthermore, the number of segments is human defined. There is little insight to the maximum number of segments that could be achieved without violating business requirements. All of this is undesirable.

### BRIEF DESCRIPTION OF THE FIGURES

FIG. 1 is a block diagram of an example system that can provide flexible, multi-constraint segmentation according to some embodiments of the present disclosure.

FIG. 2 is a flow diagram showing example processing that can provide flexible, multi-constraint segmentation according to some embodiments of the present disclosure.

FIG. 3 is another flow diagram showing example processing that can provide flexible, multi-constraint segmentation according to some embodiments of the present disclosure.

FIGS. 4A and 4B are visual examples of bin segmentations according to some embodiments of the present disclosure.

FIG. 5 is an example comparison between prior art segmentation and flexible multi-constraint segmentation according to some embodiments of the present disclosure.

FIG. 6 is another flow diagram showing example processing that can provide flexible, multi-constraint segmentation according to some embodiments of the present disclosure.

FIG. 7 is an example server that can be used within the system of FIG. 1 according to an embodiment of the present disclosure.

FIG. 8 is an example computing device that can be used within the system of FIG. 1 according to an embodiment of the present disclosure.

### DETAILED DESCRIPTION OF SEVERAL EMBODIMENTS

Embodiments of the present disclosure overcome the existing problems associated with segmenting borrowers, such as for lending purposes. For example, the disclosed embodiments relate to a flexible, multi-constraint system for segmenting borrowers and using the borrower segmentation to determine loan approvals and pricing terms. The disclosed principles can result in higher numbers of segments, which allows for more granular pricing on behalf of loan offers. In addition, the disclosed segmentation techniques can offer enhanced differentiation of credit risk across segments (i.e., a high separation in credit risk across segments), enabling rapid and accurate decisions on loan approvals and pricing. Furthermore, the disclosed segmentation techniques allow for the flexible definition of constraints, which allows providers of capital to customize requirements as desired, enabling more effective automatic decisions for the extremely low-risk and extremely high-risk borrowers.

In one or more embodiments, the disclosed segmentation system utilizes an algorithm that classifies borrowers into small bins based on given credit risk scores. The disclosed algorithm uses a mixed integer programming (MIP) model to group the bins into a specific number of segments, so that the linear slope of default rates across the segments is maximized. As described herein, a segment can include one or more bins or scores, thereby also comprising a certain number of user scores and, thereby defining a range of scores. Because credit risk scores are used to rank customers in terms of default risk, the resulting segments can follow a monotonic trend in default rates (i.e., the similarity among borrowers within the same segment is high). Notably, monotonicity of default rates within segments cannot be guaranteed by clustering or decision tree models; hence, the disclosed segmentation techniques offer distinct technical advantages over previous systems.

Attempts have previously been made in the field of credit risk scoring models to increase general credit risk prediction accuracy. However, there is limited research on posterior segmentation based on credit risk score. Customer segmentation could be developed for scorecard construction by business judgement or clustering analysis (e.g., hierarchical clustering, k-means, etc.). In addition, credit bureaus have occasionally adopted tree-based classification methods and genetic algorithms for customer segmentation; however, these result in sub-optimal solutions. For example, after scores are put into bins or buckets, the subsequent segmentation typically involves manual combinations of buckets based on business expertise to get down to a certain number of customer segments or to fix default rates that do not follow a monotonic trend. A problem with these approaches is that they are not repeatable or reproducible, updates require manual editing, and they are not automated or maximally accurate. The techniques can be arbitrary and hard to correlate with business or earning objectives, which are undesirable.

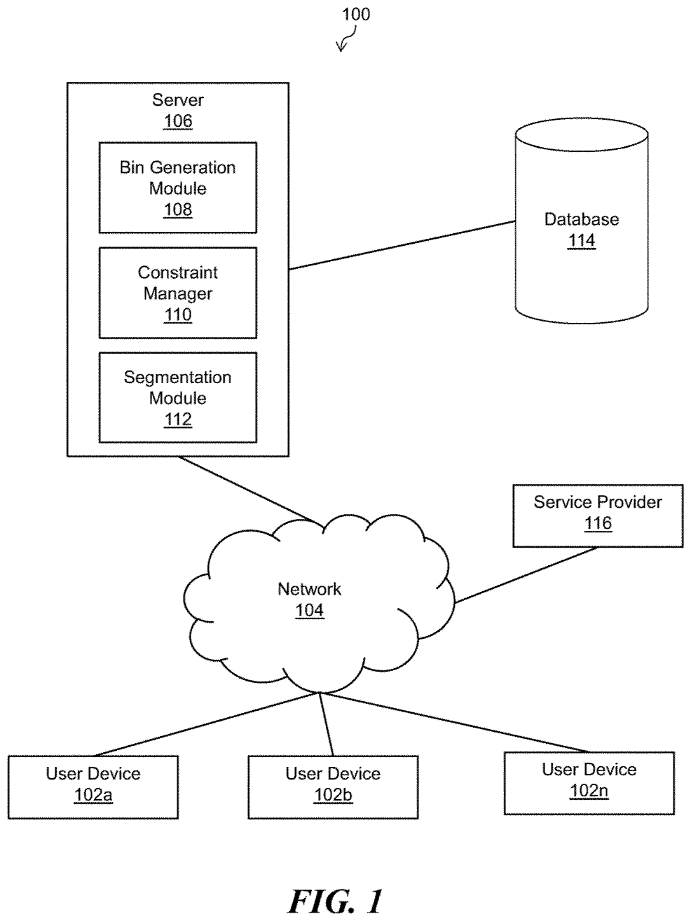

FIG. 1 is a block diagram of an example flexible, multi-constraint system 100 according to some embodiments of the present disclosure. The system 100 can include a plurality of user devices 102a-n (generally referred to herein as a “user device 102” or collectively referred to herein as “user devices 102”) and a server 106, which are communicably coupled via a network 104. Components of the system 100 can also communicate with one or more service providers 116 (e.g., providers of financial capital) via the network 104. In some embodiments, the server 106 is configured to generate a segmentation model on behalf of a service provider 116; the server 106 can receive one or more constraints for a model from the service provider 116 and, based on credit orthiness data from database 114, generates a segmentation model. The generated segmentation model is used by service provider 116 to process future credit and/or loan applications on behalf of prospective borrowers received e.g., from a user device 102.

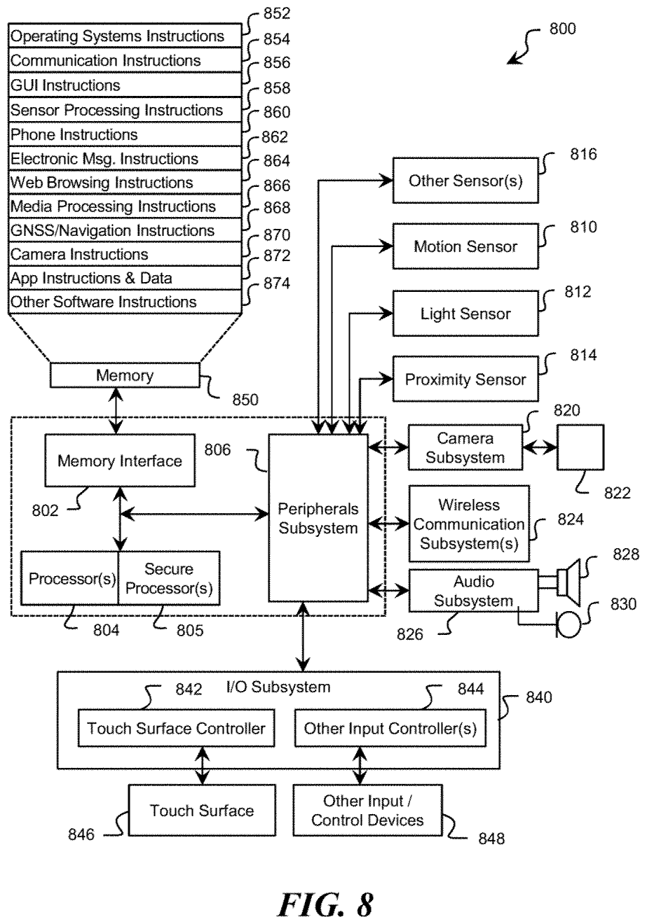

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, or other suitable device. In some embodiments, a user device 102 can be the same as or similar to the computing device 800 described below with respect to FIG. 8. In some embodiments, the system 100 can include any number of user devices 102.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

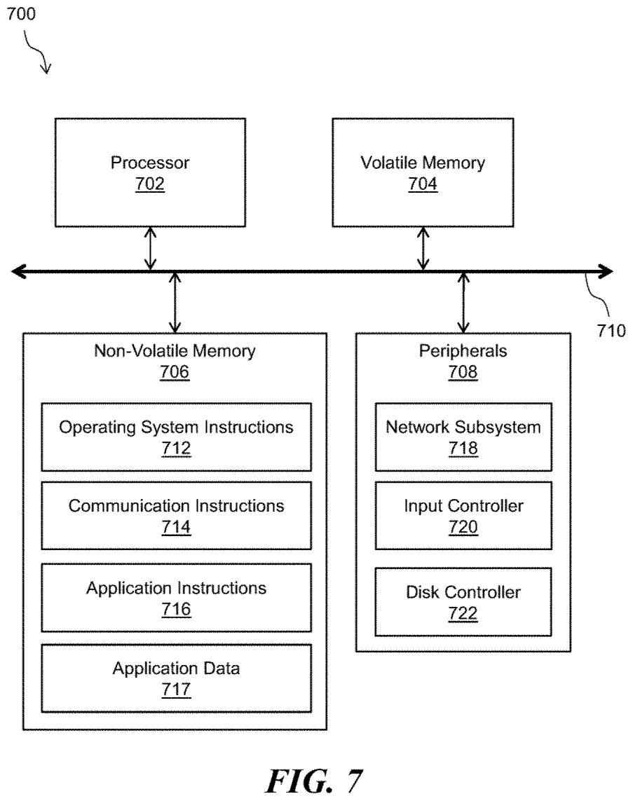

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 700 described below in the context of FIG. 7.

As shown in FIG. 1, the server 106 includes a bin generation module 108, a constraint manager 110, and a segmentation module 112. The server 106 is communicably coupled to the database 114 and can access datasets of customer credit/loan scores and historical loan default events. In one or more embodiments, bin generation module 108 is configured to, given a dataset of scores, generate a plurality of bins and divide the scores into the bins. In some embodiments, bin generation module 108 can utilize a variety of binning techniques, such as a Classification and Regression Tree (CART) model or a quantile-based model. In some embodiments, the binning technique is selected by a user associated with the service provider 116. The constraint manager 110 is configured to receive user-defined constraints from the service provider 116, format the constraints into mathematical relationships, and provide the constraints to the segmentation module 112 so that the constraints are considered while developing the segmentation model. Segmentation module 112 can be configured to generate a segmentation model, e.g., by using a mixed integer programming (MIP) technique to generate segments based on the bins generated by bin generation module 108 and based on the constraints received from the constraint manager 110.

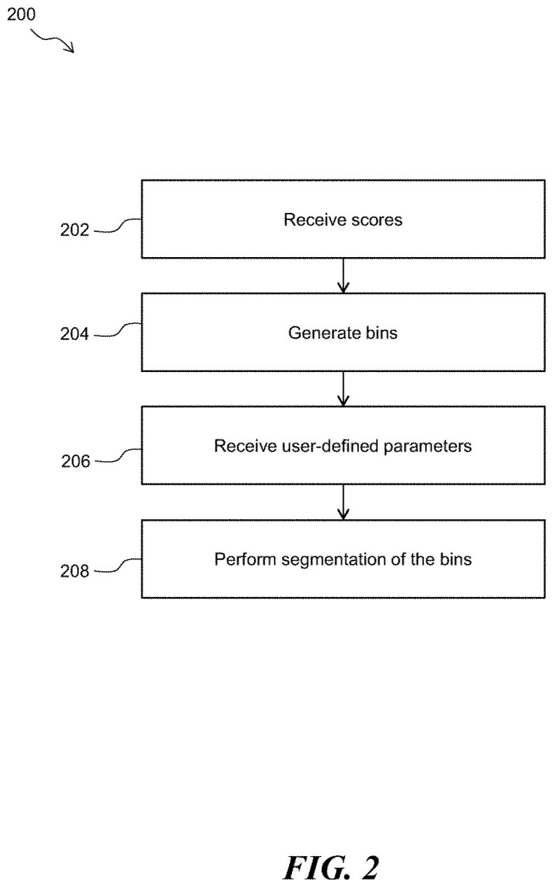

FIG. 2 is a flow diagram showing example process 200 that can provide flexible, multi-constraint segmentation according to some embodiments of the present disclosure. Process 200 can be performed by the server 106 and its various modules. At block 202, bin generation module 108 receives a dataset including credit scores or loan risk scores and historical loan default events associated with a user base. In some embodiments, the dataset of credit scores can be obtained from a public database, such as database 114. In some embodiments, the dataset can be manually provided to the bin generation module 108 by a service provider, such as service provider 116. For example, the service provider may wish to generate a model based on an internal population of data. The received scores can include a variety of score types, such as credit scores calculated by machine learning models based on a credit history. In some embodiments, the score can reflect a probability of a default or a likelihood that the associated person would default on a loan.

At block 204, bin generation module 108 generates a plurality of bins based on the dataset of scores. Generating a plurality of bins can include grouping the population of scores into small, consecutive bins. In some embodiments, bin generation module 108 can employ a CART model or a quantile-based model. In some embodiments, the number of bins can be between twenty and one hundred. The default rates within the bins may not necessarily be monotonically increasing or decreasing but may have local flips. At block 206, constraint manager 110 can receive user-defined parameters and format the parameters into constraints for use in generating the segmentation model. In some embodiments, flexible constraints (e.g., constraints based on user definable parameters) can include the number of desired risk segments, a minimum number (or percentage) of scores per risk segment, a maximum number (or percentage) of scores per segment sizes, and a minimum number of defaults per risk segment. Other constraints can include the following:

max f(x, w) (1)

s.t. Σᵢ₌ⱼⁿxᵢⱼ=1 ∀j=1, . . . , n (2)

xᵢⱼ≤x_{i,j+1} ∀i=1, . . . , n j=1, . . . , i−1 (3)

Σᵢ₌ⱼⁿxᵢᵢ=m (4)

Rₘᵢₙxᵢᵢ≤Σⱼ₌₁ⁱRⱼxᵢⱼ≤Rₘₐₓxᵢᵢ ∀i=1, . . . , n (5)

Σⱼ₌₁ⁱRⱼ^{E}xᵢⱼ≥Rₘᵢₙ^{E}xᵢᵢ ∀i=1, . . . , n (6)

D_{zz}x_{zz}+Σⱼ₌₁^{z-1}(D_{zj}−D_{z,j+1})x_{zj}≤1−xᵢᵢ+Dᵢᵢxᵢᵢ+Σⱼ₌₁ⁱ⁻¹(Dᵢⱼ−D_{i,j+1})xᵢⱼ ∀i=1, . . . , n z=1, . . . , i−1 (7)

wᵢⱼ≤(xᵢⱼ−x_{i,j-1})m ∀i=2, . . . , n j=2, . . . , i (8)

wᵢⱼ≥m(xᵢⱼ−x_{i,j-1})+Σ_{z=1}ⁱx_{zz} ∀i=2, . . . , n j=2, . . . , i (9)

wᵢⱼ≤Σ_{z=1}ⁱx_{zz}+1−(xᵢⱼ−x_{i,j-1})∀i=2, . . . , n j=2, . . . , i (10)

wᵢ₁=xᵢ₁ ∀i=1, . . . , n (11)

xᵢⱼ ϵ{0,1}, wᵢⱼ ϵZ i=1, . . . , n, j=1, . . . , i (12)

Rₘᵢₙ(1−xᵢ₁)+Rₘᵢₙ^{F}xᵢ₁≤Σⱼ₌₁ⁱRⱼxᵢⱼ≤Rₘₐₓ i=1, . . . , n−1 (13)

Rₘᵢₙ^{L}≤Σⱼ₌₁ⁿRⱼxₙⱼ≤Rₘₐₓ (14)

Σⱼ₌₁ⁱRⱼ^{E}xᵢⱼ≥Rₘᵢₙ^{E}(1−xᵢ₁)+Rₘᵢₙ^{EF}xᵢ₁ ∀i=1, . . . , n−1 (15)

Σⱼ₌₁ⁿRⱼ^{E}xₙⱼ≥Rₘᵢₙ^{EL} (16).

Objective function (1) is the function f (defined below) to be maximized. Constraints (2) and (3) can be used to make sure that the bin assignment to segments is unique and consecutive. Constraint (4) can be used to set the number of segments to m (which can be user-defined or can be determined and maximized). Constraints (5) and (6) can be used to set the bounds on segment size and number of defaults per segment. Constraint (7) can be used to ensure that default rates increase monotonically with the rank order of segments. In some embodiments, constraint (7) can also be used to ensure that default rates decrease monotonically with the rank order of the segments. Constraints (8)-(11) can be used to relate segment rank order with bin assignment. Constraint (12) can be used to define the space of decision variables (discussed in additional detail in block 208).

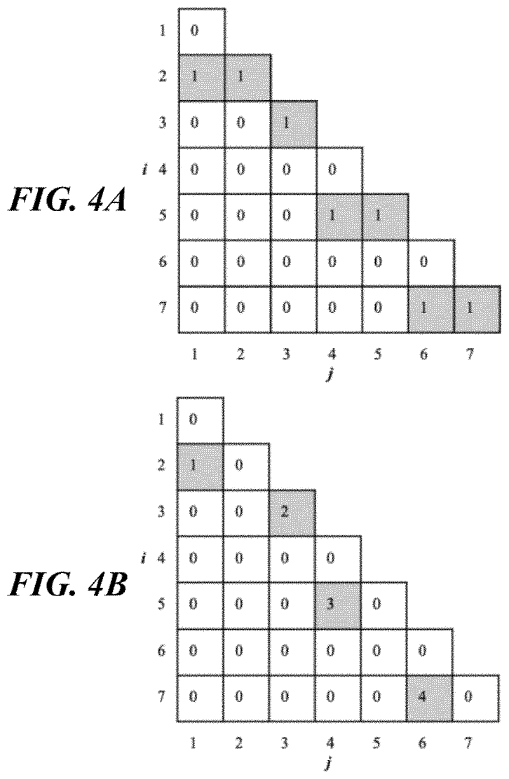

Constraint (5) can accommodate a flexible segment size. Constraint (13) can be used to limit the bounds of segment sizes on the first to the second to last segments (i.e., all segments except the last segment). Constraint (14) can be used to set the lower bound on the size of the last segment. Similarly, constraint (6) can be split into two constraints, constraints (15) and (16), and used for customizing lower bounds on the number of defaults in the first and last segment. In these constraints, and in future equations described herein, w is the rank order of a risk segment formed by grouping bins [j, j+1, . . . , i] together and x is a matrix describing bin assignments (see FIG. 4A) where: wᵢⱼ=Σ_{z=1}ⁱx_{zz}. In addition, values of w can be determined as follows: wᵢⱼ=xᵢᵢ if j≥2 and xᵢⱼ−x_{i,j-1}=1. Finally, wᵢⱼ=0 otherwise. In addition, m is the number of segments, n is the number of bins, i and j are used as indices to cycle between matrix elements, and f is the objective function, defined in further detail below.

In some embodiments, for certain use cases, service provider 116 may wish to find the extreme low-risk and high-risk segments for automated approvals and denials. The two extreme segments do not have to have significant numbers of records and/or numbers of defaults as the middle segments. Therefore, a set of flexible constraints allows the service provider 116 to customize the requirements in the first and last segment (e.g., based on profit, business goals, market conditions, etc.). For example, Rₘᵢₙ^{F}(Rₘᵢₙ^{L}) can be the minimum number of records in the first (or last) segment, and Rₘᵢₙ^{EF}(Rₘᵢₙ^{EL}) can be the minimum number of defaults in the first (or last) segment. Additionally or alternatively, these R values can be used to define the maximum number of records and/or defaults in each segment. For example, it could be desired that the first bin's size could go as low as five percent of the total population, and the number of defaults could be as low as ten. In order to enable these flexible constraints (variations of constraints (5) and (6)), users can specify multiple input parameters: 1) a minimum number of scores in the last risk segment; 2) a minimum number of scores in the first to the second last risk segments; 3) a minimum number of default events in the last risk segment; and 4) a minimum number of default events in the first to the second last risk segments. In some embodiments, a user associated with service provider 116 could specify these parameters via a graphical user interface; the parameters are transmitted over the network 104 to the server 106 and processed by the constraint manager 110 to be utilized by segmentation module 112.

At block 208, segmentation module 112 can segment the bins generated by the bin generation module 108. In some embodiments, segmentation can include calculating segment default rates for each segment. For example, segmentation module 112 can, for each segment, calculate an associated default rate that represents the segment (herein described as a “segment default rate”). The segment default rate can be calculated as follows:

$${D}_{i j} = \frac{{\sum }_{z = j}^{i} {R}_{z}^{E}}{{\sum }_{z = j}^{i} {R}_{z}}$$

where R_{z} is the number of loans and R_{z}^{E} is the number of defaults from the loans.

In some embodiments, segmenting the bins includes determining a segment default rate for each segment and using an MIP model to group the small bins into risk segments such that the linear slope of default rates among risk segments is maximized or close to maximized, without violating the provided constraints. In some embodiments, maximizing a linear slope of default rates includes maximizing the objective function below:

$$f ( x , w ) = m {\sum }_{i - 1}^{n} {\sum }_{j = 1}^{i} {D}_{ij} {w}_{ij} - \frac{m ( m + 1 )}{2} {\sum }_{i = 1}^{n} ( {D}_{ii} {x}_{ii} + {\sum }_{j = 1}^{i - 1} ( {D}_{ij} - {D}_{i , j + 1} ) {x}_{ij} ) .$$

The above objective function can be based on a linear regression of the segment default rates of the segments generated by segmentation module 1012 that minimizes the least squared loss. Maximizing the objective function can correspond to maximizing the slope of the default rates, which suggests a maximal difference in default rates across each segment. The MIP model can create permutations of segmentations of the bins, determine the associated segment default rate for each segment, and then use those default rates and the provided constraints to maximize the objective function. For example, if six segments are desired and there are twenty bins, there are 11,628 potential ways to segment the bins. In some embodiments, the segmentation module 112 can iteratively solve the MIP model with increasing numbers of segments until there is no feasible solution without violating business requirements. This allows an increased granularity among the segmented scores while maintaining high monotonicity within each segment and high differences in default rates across different segments. In some embodiments, as an alternative to a linear regression, the segmentation module 112 could also employ an exponential regression and maximize the slope of the exponential regression. The techniques described herein determine the segmentation with the largest slope, which is a more effective way to make loan or credit decisions. In the case of exponential regression, the definition of w could be modified to the negative of the logarithm of the default rates, and the objective would be to minimize the objective function.

In some embodiments, as an alternative to MIP models, other optimization techniques can be used to maximize the slope, such as convex functions, gradient methods, Lagrangian relaxation, heuristic algorithms, genetic algorithms, and other iterative techniques.

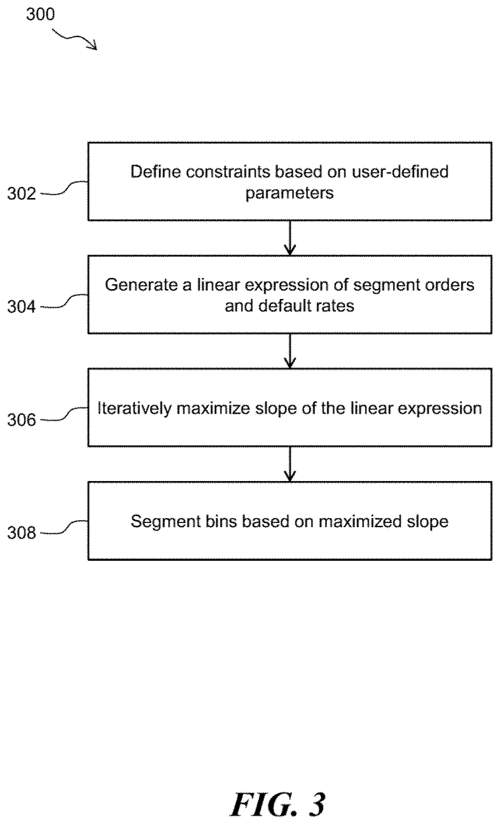

FIG. 3 is another flow diagram showing example process 300 that can provide flexible, multi-constraint segmentation according to some embodiments of the present disclosure. In some embodiments, process 300 can be performed by constraint manager 110 and segmentation module 112 at block 208 of process 200. In other words, process 300 can be performed after a plurality of bins have been generated, where each bin comprises one or more scores and associated default events. At block 302, constraint manager 110 defines and formats the constraints mathematically based on user-defined parameters, such as the parameters discussed above. At block 304, segmentation module 112 generates a linear expression of segment orders and default rates. In one embodiment, segmentation module 112 calculates a segment default rate for each segment and then generates the linear expression. At block 306, segmentation module 112, via an MIP model, iteratively maximizes the slope of the linear expression by shifting and changing the various segments to explore the different segmentation permutations. At block 308, segmentation module 112 segments the bins based on the maximized slope and provides the model as an output. In some embodiments, it can be desirable to have a higher number of segments, which enables a better customization of pricing and an improvement in the propensity of customer acceptance of loan offers. Increasing the feasible number of segments can be performed by iteratively solving the model with increasing number of segments until there is no feasible solution without violating the constraints.

The segmentation model can be utilized by providers of financial capital to make credit or loan decisions based on customer applications. The disclosed techniques enable more rapid decisions on automatic approvals and denials and increased loan approval percentages while simultaneously decreasing loan default rates. In addition, the disclosed techniques are not limited to loan offers and can be applied to a variety of applications. For example, the disclosed segmentation techniques can be used to segment an attribute in building a credit scorecard and segmenting customers based on their lifetime value to design retention strategy.

FIGS. 4A and 4B are visual examples of bin segmentations according to some embodiments of the present disclosure. FIGS. 4A and 4B show an example segmentation (e.g., bin assignment matrix) for a solution with n=7 and m=4, where n is the number of bins, m is the desired number of segments, and j and i are used as indexes to denote the bins. In a real-world example, the bin generation procedure would have generated seven bins based on a population of credit scores and associated loan default events, each bin including a number of scores. The seven bins would then be segmented into four segments. An initial pre-segmentation is shown in FIG. 4A, where a first segment (row 2) comprises bins 1 and 2. The second segment (row 3) comprises bin 3 by itself. The third segment (row 5) comprises bins 4 and 5. The fourth and last segment (row 7) comprises bins 6 and 7. FIG. 4B shows a visualization of the rank ordering of the segments, where the rank (e.g., 1^{st}, 2^{nd}, 3^{rd}, 4^{th}, etc.) of the segment is provided in the matrix at the left-most bin placement. As described above, FIG. 4A shows the bin assignment matrix x, while FIG. 4B shows the segment rank order matrix w. The MIP model can utilize and solve these matrices to determine optimal segmentations of the bins.

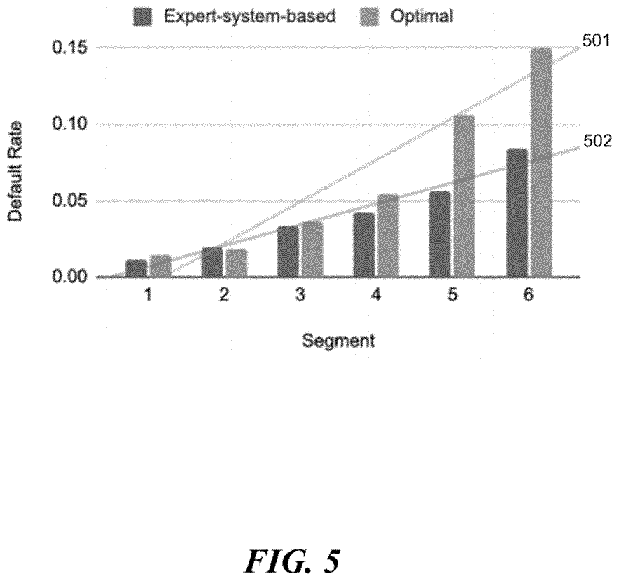

FIG. 5 is an example comparison between prior art segmentation (line 502) and the flexible multi-constraint segmentation (line 501) according to some embodiments of the present disclosure. The prior art segmentation method is based on an expert-based system. An expert-based system can use human knowledge and experience based on industry standards or other best practices. Human “experts” attempt to manually put together bins based on similarities in rates and scores. In this comparison, both methods were utilized to segment sixty-six bins into six segments. The x-axis shows the rank order of each risk segment, while the y-axis shows the default rate. The left bar for each segment is a segment generated via the expert-based system, and the linear regression line reflecting those segments is line 502. In addition, the right bar for each segment is a segment generated via the disclosed segmentation techniques, and the linear regression line reflecting those segments is line 501. The slope of line 502 is around 0.0137, while the slope of line 501 is around 0.027. A higher slope, as described herein, suggests that there is greater differentiation between each risk segment. For example, the default rates in segments 5 and 6 for the expert-based system are around 0.055 and 0.08, respectively, while the default rates in segments 5 and 6 for the disclosed segmentation technique are around 0.105 and 0.15, respectively. This suggests that the disclosed techniques can be more effective at identifying high risk profiles and separating them into their own risk segment. It is common for capital providers to design their systems to automatically deny requests that fall into the high-risk segment; however, their issue is that currently existing systems are not as effective at segmenting the high-risk requests. This allows for twofold benefits, such as increasing the number of approved loans on behalf of a provider (i.e., the provider can increase their earnings because they are generating interest on a higher number of loans) and reducing the overall default rate (i.e., losing less money on loans that are not paid back).

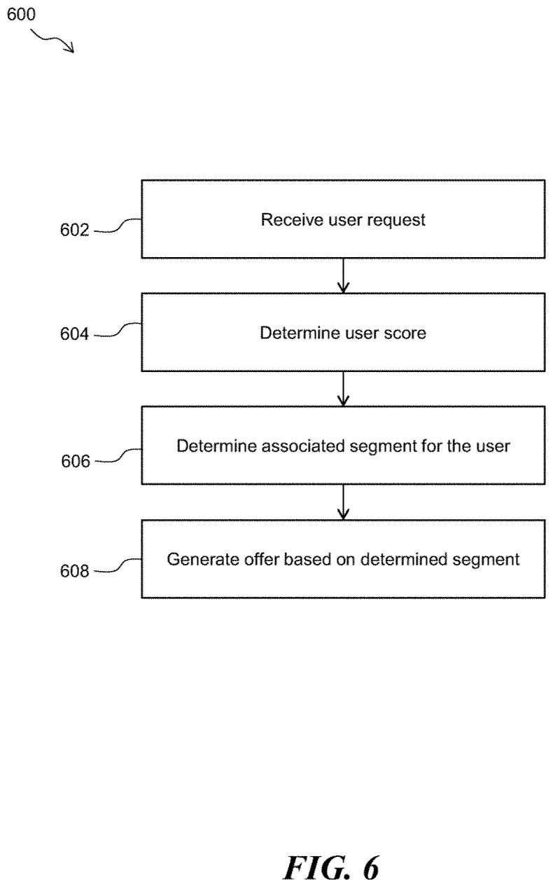

FIG. 6 is another flow diagram showing example process 600 that can provide flexible, multi-constraint segmentation according to some embodiments of the present disclosure. In some embodiments, process 600 can utilize a model generated in FIGS. 2 and 3 to process a loan-based or credit-based request from a customer. Process 600 can be performed by server 106, or by service provider 116, or any other computing device that is capable of running the models described herein. At block 602, the device receives a user request, such as for a loan or other type of credit. For example, a user could submit a user request via user device 102, such as by via an application through a web browser. At block 604, the device that receives the user request determines a user score. In some embodiments, this can include obtaining a credit profile or other similar mechanism to obtain a credit score or loan history score associated with the request. In some embodiments, the score can be maintained internally by a provider of capital, or it can be accessed from an external database.

At block 606, the device determines an associated risk segment for the user based on the determined score. For example, given a plurality of risk segments (each containing a range of scores), the received request can be assigned to a particular risk segment. In one or more embodiments, the plurality of risk segments would have been generated based on the methods of FIGS. 2 and 3. At block 608, the device generates an offer associated with the request based on the determined risk segment. For example, if the request is determined to be in the lowest risk segment, the offer can include an automatic approval with pre-specified pricing terms (e.g., loan term, interest rate, etc.). In another example, if the request is determined to be in the highest risk segment, the offer can include an automatic denial. In other examples, if the request is determined to fall in a middle range risk segment, the offer can be queued for manual review and approval.

FIG. 7 is a diagram of an example server device 700 that can be used within system 100 of FIG. 1. Server device 700 can implement various features and processes as described herein. Server device 700 can be implemented on any electronic device that runs software applications derived from complied instructions, including without limitation personal computers, servers, smart phones, media players, electronic tablets, game consoles, email devices, etc. In some implementations, server device 700 can include one or more processors 702, volatile memory 704, non-volatile memory 706, and one or more peripherals 708. These components can be interconnected by one or more computer buses 710.

Processor(s) 702 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 710 can be any known internal or external bus technology, including but not limited to ISA, EISA, PCI, PCI Express, USB, Serial ATA, or FireWire. Volatile memory 704 can include, for example, SDRAM. Processor 702 can receive instructions and data from a read-only memory or a random access memory or both. Essential elements of a computer can include a processor for executing instructions and one or more memories for storing instructions and data.

Non-volatile memory 706 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 706 can store various computer instructions including operating system instructions 712, communication instructions 714, application instructions 716, and application data 717. Operating system instructions 712 can include instructions for implementing an operating system (e.g., Mac OS®, Windows®, or Linux). The operating system can be multi-user, multiprocessing, multitasking, multithreading, real-time, and the like. Communication instructions 714 can include network communications instructions, for example, software for implementing communication protocols, such as TCP/IP, HTTP, Ethernet, telephony, etc. Application instructions 716 can include instructions for performing flexible, multi-constraint segmentation techniques according to the systems and methods disclosed herein. For example, application instructions 716 can include instructions for components 108-112 described above in conjunction with FIG. 1. Application data 717 can include data corresponding to 108-112 described above in conjunction with FIG. 1.

Peripherals 708 can be included within server device 700 or operatively coupled to communicate with server device 700. Peripherals 708 can include, for example, network subsystem 718, input controller 720, and disk controller 722. Network subsystem 718 can include, for example, an Ethernet of WiFi adapter. Input controller 720 can be any known input device technology, including but not limited to a keyboard (including a virtual keyboard), mouse, track ball, and touch-sensitive pad or display. Disk controller 722 can include one or more mass storage devices for storing data files; such devices include magnetic disks, such as internal hard disks and removable disks; magneto-optical disks; and optical disks.

FIG. 8 is an example computing device that can be used within the system 100 of FIG. 1, according to an embodiment of the present disclosure. In some embodiments, device 800 can be any of user devices 102a-n. The illustrative user device 800 can include a memory interface 802, one or more data processors, image processors, central processing units 804, and/or secure processing units 805, and peripherals subsystem 806. Memory interface 802, one or more central processing units 804 and/or secure processing units 805, and/or peripherals subsystem 806 can be separate components or can be integrated in one or more integrated circuits. The various components in user device 800 can be coupled by one or more communication buses or signal lines.

Sensors, devices, and subsystems can be coupled to peripherals subsystem 806 to facilitate multiple functionalities. For example, motion sensor 810, light sensor 812, and proximity sensor 814 can be coupled to peripherals subsystem 806 to facilitate orientation, lighting, and proximity functions. Other sensors 816 can also be connected to peripherals subsystem 806, such as a global navigation satellite system (GNSS) (e.g., GPS receiver), a temperature sensor, a biometric sensor, magnetometer, or other sensing device, to facilitate related functionalities.

Camera subsystem 820 and optical sensor 822, e.g., a charged coupled device (CCD) or a complementary metal-oxide semiconductor (CMOS) optical sensor, can be utilized to facilitate camera functions, such as recording photographs and video clips. Camera subsystem 820 and optical sensor 822 can be used to collect images of a user to be used during authentication of a user, e.g., by performing facial recognition analysis.

Communication functions can be facilitated through one or more wired and/or wireless communication subsystems 824, which can include radio frequency receivers and transmitters and/or optical (e.g., infrared) receivers and transmitters. For example, the Bluetooth (e.g., Bluetooth low energy (BTLE)) and/or WiFi communications described herein can be handled by wireless communication subsystems 824. The specific design and implementation of communication subsystems 824 can depend on the communication network(s) over which the user device 800 is intended to operate. For example, user device 800 can include communication subsystems 824 designed to operate over a GSM network, a GPRS network, an EDGE network, a WiFi or WiMax network, and a Bluetooth™ network. For example, wireless communication subsystems 824 can include hosting protocols such that device 800 can be configured as a base station for other wireless devices and/or to provide a WiFi service.

Audio subsystem 826 can be coupled to speaker 828 and microphone 830 to facilitate voice-enabled functions, such as speaker recognition, voice replication, digital recording, and telephony functions. Audio subsystem 826 can be configured to facilitate processing voice commands, voice-printing, and voice authentication, for example.

I/O subsystem 840 can include a touch-surface controller 842 and/or other input controller(s) 844. Touch-surface controller 842 can be coupled to a touch-surface 846. Touch-surface 846 and touch-surface controller 842 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 846.

The other input controller(s) 844 can be coupled to other input/control devices 848, such as one or more buttons, rocker switches, thumb-wheel, infrared port, USB port, and/or a pointer device such as a stylus. The one or more buttons (not shown) can include an up/down button for volume control of speaker 828 and/or microphone 830.

In some implementations, a pressing of the button for a first duration can disengage a lock of touch-surface 846; and a pressing of the button for a second duration that is longer than the first duration can turn power to user device 800 on or off. Pressing the button for a third duration can activate a voice control, or voice command, module that enables the user to speak commands into microphone 830 to cause the device to execute the spoken command. The user can customize a functionality of one or more of the buttons. Touch-surface 846 can, for example, also be used to implement virtual or soft buttons and/or a keyboard.

In some implementations, user device 800 can present recorded audio and/or video files, such as MP3, AAC, and MPEG files. In some implementations, user device 800 can include the functionality of an MP3 player, such as an iPod™. User device 800 can, therefore, include a 36-pin connector and/or 8-pin connector that is compatible with the iPod. Other input/output and control devices can also be used.

Memory interface 802 can be coupled to memory 850. Memory 850 can include high-speed random access memory and/or non-volatile memory, such as one or more magnetic disk storage devices, one or more optical storage devices, and/or flash memory (e.g., NAND, NOR). Memory 850 can store an operating system 852, such as Darwin, RTXC, LINUX, UNIX, OS X, Windows, or an embedded operating system such as VxWorks.

Operating system 852 can include instructions for handling basic system services and for performing hardware dependent tasks. In some implementations, operating system 852 can be a kernel (e.g., UNIX kernel). In some implementations, operating system 852 can include instructions for performing voice authentication.

Memory 850 can also store communication instructions 854 to facilitate communicating with one or more additional devices, one or more computers and/or one or more servers. Memory 850 can include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic messaging-related process and functions; web browsing instructions 864 to facilitate web browsing-related processes and functions; media processing instructions 866 to facilitate media processing-related functions and processes; GNSS/Navigation instructions 868 to facilitate GNSS and navigation-related processes and instructions; and/or camera instructions 870 to facilitate camera-related processes and functions.

Memory 850 can store application (or “app”) instructions and data 872, such as instructions for the apps described above in the context of FIGS. 1-6. Memory 850 can also store other software instructions 874 for various other software applications in place on device 800.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings. Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method, performed by at least one processor, of segmenting default likelihoods, said method comprising:
receiving loan performance data;
generating a plurality of bins using one of a Classification and Regression Tree (CART) model, a quantile-based model, or a clustering method, each bin comprising at least a portion of the loan performance data;
performing segmentation of the bins based on at least one constraint to create a plurality of segments, each segment comprising at least one bin of the plurality of bins and the segmentation being based on a slope of default rates across segments, wherein performing segmentation of the bins comprises:
calculating a plurality of segment default rates, the plurality of segment default rates comprising a segment default rate for each of the plurality of segments;
generating a linear or an exponential expression of the plurality of segment default rates; and
calculating a slope of the respective linear or exponential expression;
receiving a loan-based or credit-based request;
identifying, from the plurality of segments, a segment associated with the request; and
generating an offer for the request based on the identified segment associated with the request.

2. (canceled)

3. The method of claim 1, wherein performing segmentation of the bins comprises segmenting the bins using a mixed integer programming (MIP) model.

4. (canceled)

5. The method of claim 1, further comprising iteratively performing the calculating, generating, and calculating steps with an increasing number of segments until a maximal number of segments is achieved without violating the at least one constraint.

6. The method of claim 1, further comprising iteratively performing the generating and second calculating steps until the slope is maximized.

7. (canceled)

8. The method of claim 1, wherein the at least one constraint comprises at least one of:
a minimum number of records in a last segment;
a maximum number of records in the last segment;
a minimum number of records in at least one of a first to a second to last segment;
a maximum number of records at least one of the first to the second to last segment;
a minimum number of default events in the last segment;
a maximum number of default events in the last segment;
a maximum number of default events in at least one of the first to the second to last segment; or
a minimum number of default events in at least one of the first to the second last segment.

9. The method of claim 1, wherein the at least one constraint comprises a number of desired segments specified by a user.

10. A system comprising:
a processor; and
a non-transitory computer-readable medium storing instructions that, when executed by the processor, causes the processor to perform a method of segmenting default likelihoods comprising:
receiving loan performance data;
generating a plurality of bins using one of a Classification and Regression Tree (CART) model, a quantile-based model, or a clustering method, each bin comprising at least a portion of the loan performance data;
receiving at least one parameter that defines a constraint;
performing segmentation of the bins based on the constraint to create a plurality of segments, wherein each segment comprises at least one bin of the plurality of bins, wherein performing segmentation of the bins comprises:
calculating a plurality of segment default rates, the plurality of segment default rates comprising a segment default rate for each of the plurality of segments;
generating a linear or an exponential expression of the plurality of segment default rates; and
calculating a slope of the respective linear or exponential expression; and
generating an offer based on the segmentation.

11. (canceled)

12. The system of claim 10, wherein performing segmentation of the bins comprises segmenting the bins using a mixed integer programming (MIP) model.

13. (canceled)

14. The system of claim 10 comprising iteratively performing the calculating, generating, and calculating steps with an increasing number of segments until the slope is maximized.

15. The system of claim 10 comprising iteratively performing the generating, and second calculating steps until a maximal number of segments is achieved without violating the constraint.

16. The system of claim 10, wherein the at least one parameter comprises at least one of:
a minimum number of records in a last segment;
a maximum number of records in the last segment;
a minimum number of records in at least one of a first to a second to last segment;
a maximum number of records in at least one of the first to the second to last segment;
a minimum number of default events in the last segment;
a maximum number of default events in the last segment;
a maximum number of default events in at least one of the first to the second to last segment; or
a minimum number of default events in at least one of the first to the second to last segment.

17. (canceled)

18. The system of claim 10, wherein the at least one parameter comprises a number of desired segments.

19. A system comprising:
one or more processors; and
one or more non-transitory computer-readable media storing instructions that, when executed by the one or more processors, cause the computing system to perform operations, the operations comprising:
receiving a loan-based or credit-based request;
obtaining loan performance data associated with the request;
determining a risk segment of a plurality of risk segments for the request, wherein the plurality of risk segments were generated based on a slope of default rates of a plurality of segments of historical loan performance data, wherein the plurality of segments were generated by:
calculating a plurality of segment default rates, the plurality of segment default rates comprising a segment default rate for each of the plurality of segments;
generating a linear or an exponential expression of the plurality of segment default rates; and
calculating a slope of the respective linear or exponential expression; and
generating an offer for the request based on the risk segment.

20. The system of claim 19, wherein the plurality of risk segments were generated using a mixed integer programming (MIP) model.
